(19) United States
(12) Patent Application Publication
(10) Pub. No.: US 2014/0047879 A1
(43) Pub. Date: Feb. 20, 2014

(54) Lock with a Rotational Indicator of Status

(71) Applicant: CHUN TE YU, CHANGHUA COUNTY (TW)

(72) Inventor: CHUN TE YU, CHANGHUA COUNTY (TW)

(21) Appl. No.: 13/967,931

(22) Filed: Aug. 15, 2013

(30) Foreign Application Priority Data
Aug. 16, 2012 (TW) 101129820

(51) Int. Cl. E05B 41/00

(52) U.S. Cl. CPC E05B 41/00
USPC 70/344

(57) ABSTRACT

A lock includes a body, a key-operable locking mechanism and a rotational indicator. The locking mechanism includes a spindle and a block. The spindle includes a key hole in an end and is connected, at another end, to the block to allow the block to be rotated from a locking position to an unlocking position. The indicator is disposed in the lock body, and includes, at a front end, a recess for receiving the block. With the indicator in the original position, as the block is rotated to the unlocking position, the block pushes a first side wall of the recess of the indicator to rotate the indicator to an indicating position. When the indicator is in the indicating position, a space is defined between a second side wall of the recess of the indicator and the block, and the block is moved in the space.

### BACKGROUND OF INVENTION

1. Field of Invention

The present invention relates to a lock and, more particularly, to a lock that includes a rotational indicator connected to a key-operable locking mechanism so that the indicator is movable into an indicating position from an original position by the key-operable locking mechanism and that the indicator is not returnable into the original position by the key-operable locking mechanism.

2. Related Prior Art

As disclosed in Taiwanese Patent 1235778, a conventional lock includes a rotational indicator. As shown in FIGS. 9 to 12 of the Taiwanese patent, the conventional lock includes a core and a latch in addition to the indicator. The indicator includes a lower end connected to the core so that the indicator can be rotated into an indicating position from an original position by the core. The latch is on a side of the indicator. The latch is in a first cutout in the indicator as the indicator is in the original position. The latch is trapped in a second cutout in the indicator to keep the indicator in the indicating position as the indicator is in the indicating position.

Another conventional lock is disclosed in Taiwanese Patent 1322216 issued to the present applicant. This conventional lock includes a core, a rod and a movable element. The rod includes an end inserted in the core and another end inserted in the movable element. As a key is inserted in the core, the key pushes the rod to move the movable element into an indicating position from an original position and the movable element is kept in the indicating position.

The present invention is intended to provide another lock with a rotational indicator.

### SUMMARY OF INVENTION

It is the primary objective of the present invention to provide a lock for indicating the change of status.

To achieve the foregoing objective, the lock includes a body for containing a key-operable locking mechanism and an indicator. The key-operable locking mechanism includes a core and a block. The core includes a key hole in a front end. The block is connected to a rear end of the core and formed with an axial protrusion, an upper radial protrusion on an upper face of the axial protrusion, a lower radial protrusion on a lower face of the axial protrusion. The core can rotate the block about the axial protrusion into an unlocking position from a locking position. The indicator is placed in the body and formed with a recess for receiving the block. The recess includes a first wall for contact with the upper radial protrusion of the block and a second wall for contact with the lower radial protrusion of the block. The indicator is rotatable into an indicating position from an original position. The upper radial protrusion of the block abuts the first wall of the recess to rotate the indicator into the indicating position from the original position when the core rotates the block into the unlocking position. There is a gap between the lower radial protrusion of the block and the second wall of the recess to allow the lower radial protrusion of the block to move toward the second wall of the recess when the core returns the block into the locking position.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a lock according to the preferred embodiment of the present invention;

FIG. 2 is an exploded view of an indicator of status, a locking mechanism and a restraining element of the lock shown in FIG. 1;

FIG. 3 is another exploded view of the indicator, the locking mechanism and the restraining element shown in FIG. 2;

FIG. 4 is a bottom view of the lock shown in FIG. 1;

FIG. 5 is a cross-sectional view of the lock shown FIG. 1, with the locking mechanism in a locking position;

FIG. 6 is another cross-sectional view of the lock shown in FIG. 5;

FIG. 7 is another cross-sectional view of the lock shown in FIG. 5;

FIG. 8 is a cross-sectional view of the lock shown in FIG. 1, with the locking mechanism in an unlocking position;

FIG. 9 is a cross-sectional view of the lock in another position than shown in FIG. 8;

FIG. 10 is another cross-sectional view of the lock shown in FIG. 8;

FIG. 11 is another cross-sectional view of the lock shown in FIG. 8;

FIG. 12 is another cross-sectional view of the lock similar to FIG. 10, with the locking mechanism returned into the locking position; and

FIG. 13 is a cross-sectional view of a tool for returning the indicator into the original position from an indicating position shown in FIG. 12.

### DETAILED DESCRIPTION OF PREFERRED EMBODIMENT

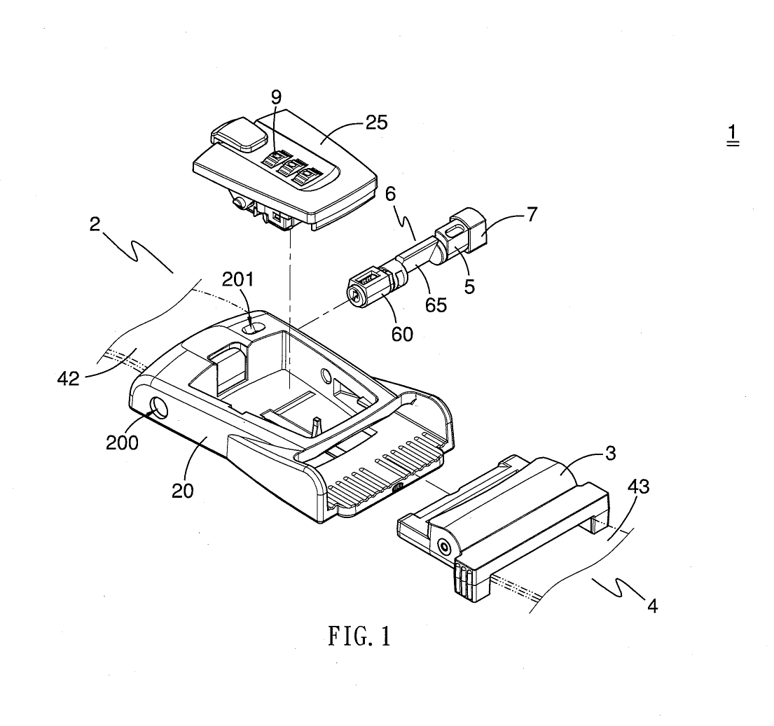

Referring to FIG. 1, there is a lock 1 according to the preferred embodiment of the present invention. The lock 1 includes a receptacle 2, a tongue 3 detachably engaged with the receptacle 2, a strap 4 connected to the receptacle 2 at an end and connected to the tongue 3 at another end, an indicator 5, a key-operable locking mechanism 6 connected to a front end of the indicator 5, and a combination locking mechanism 9.

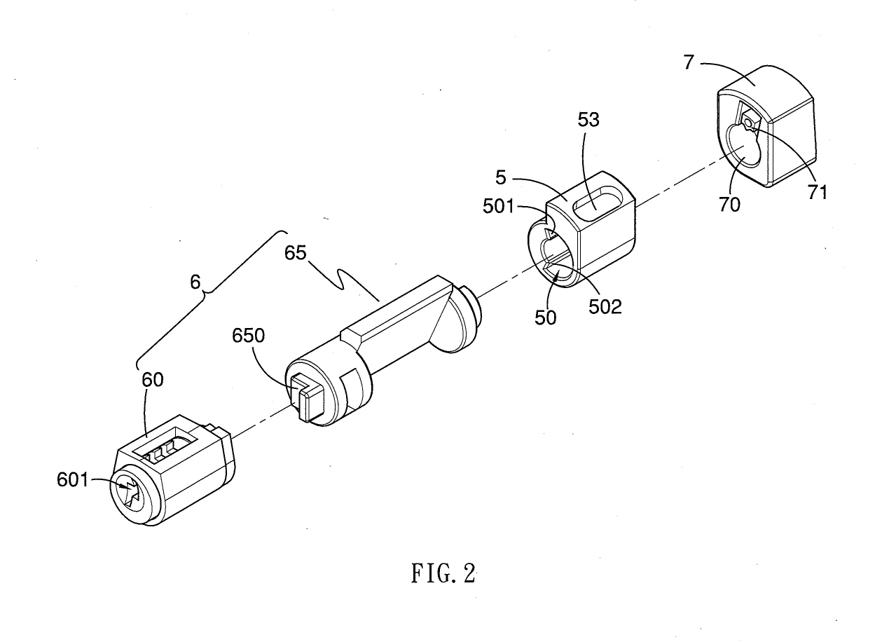

The receptacle 2 includes a body 20, a plate 25 movably placed on the body 20, and a restraining element 7 connected to a rear end of the indicator 5. The body 20 and the restraining element 7 are made independent of each other in the preferred embodiment; however, they can be made one in another embodiment. In a row, the key-operable locking mechanism 6, the indicator 5 and the restraining element 7 of the receptacle 2 are inserted in a tunnel 200 made in the body 20. The body 20 includes, on an upper face, a window 201 in communication with the tunnel 200. The indicator 5 includes an indicating portion 53 (FIG. 2) visible in the window 201. The combination locking mechanism 9 is placed on the plate 25. Each of the key-operable locking mechanism 6 and the combination locking mechanism 9 is movable into an unlocking position from a locking position to allow pressing of the plate 25 to release the tongue 3 from the receptacle 2.

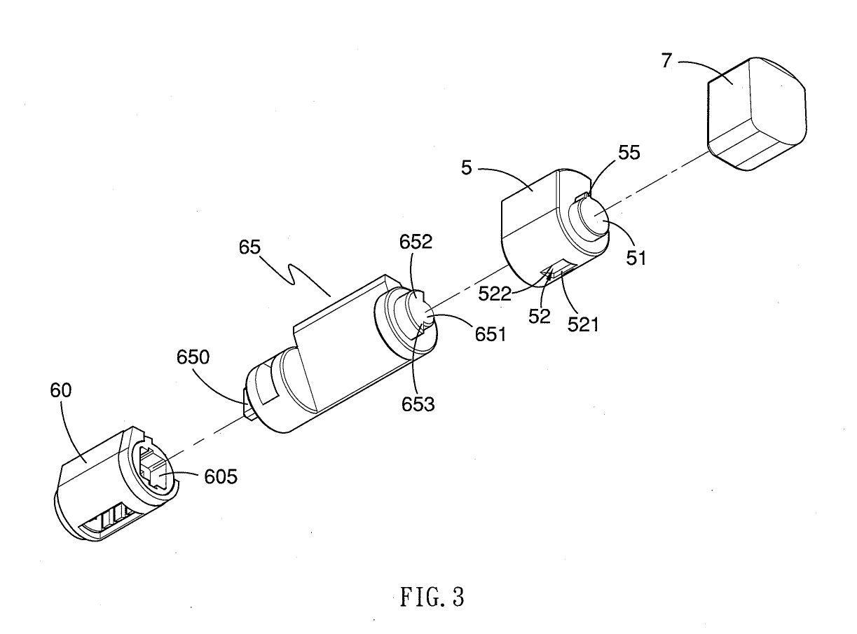

Referring to FIGS. 2 and 3, the key-operable locking mechanism 6 includes a core 60 and a block 65. The core 60 includes, at an end, a key hole 601 for receiving a key (not shown) and a recess 605 at another end. The block 65 includes a connector 650 and a driver. The connector 650 is inserted in the recess 605 so that the block 65 is rotatable by the core 60. The driver is inserted in a bore 50 made in the indicator 5. The driver includes an axial protrusion 651, an upper radial protrusion 652 extending from an upper face of the axial protrusion 651, and a lower radial protrusion 653 extending from a lower face of the axial protrusion 651. The bore 50 includes a first wall 501 for contact with the upper radial protrusion 652 and a second wall 502 for contact with the lower radial protrusion 653. The driver of the block 65 is rotated about the axial protrusion 651 inserted in the bore 50 as the core 60 is rotated.

The indicator 5 includes an insert 51 placed in a recess 70 made in the restraining element 7. The insert 51 will be placed in a recess made in the receptacle 2 if the restraining element 7 is made part of the receptacle 2. The insert 51 is rotatable in the recess 70. The restraining element 7 includes a rod 71 formed in the recess 70. Referring to FIG. 7, the rod 71 includes a first slope 710 and a second slope 712. The insert 51 includes a boss 55 formed on the periphery thereof. The boss 55 includes a first contact face 550 and a second contact face 551. The boss 55 is movable onto a side of the rod 71 from another side of the rod 71 in a manner to be described in detail.

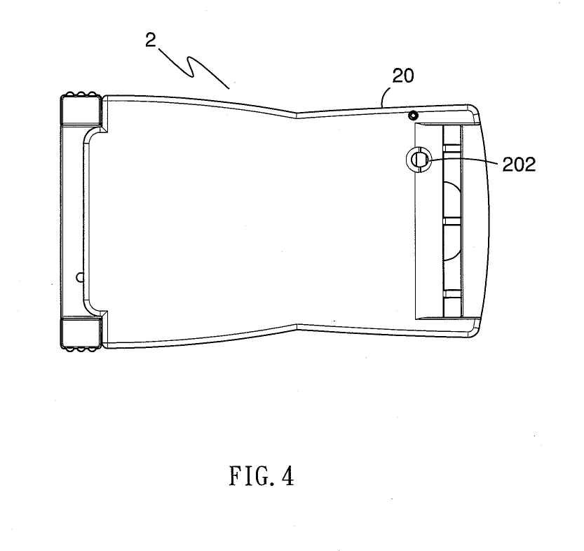

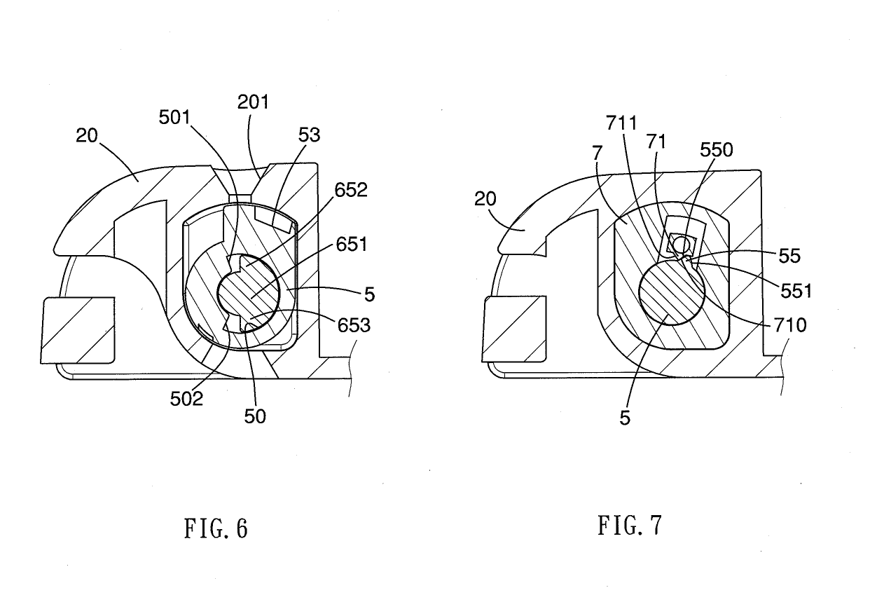

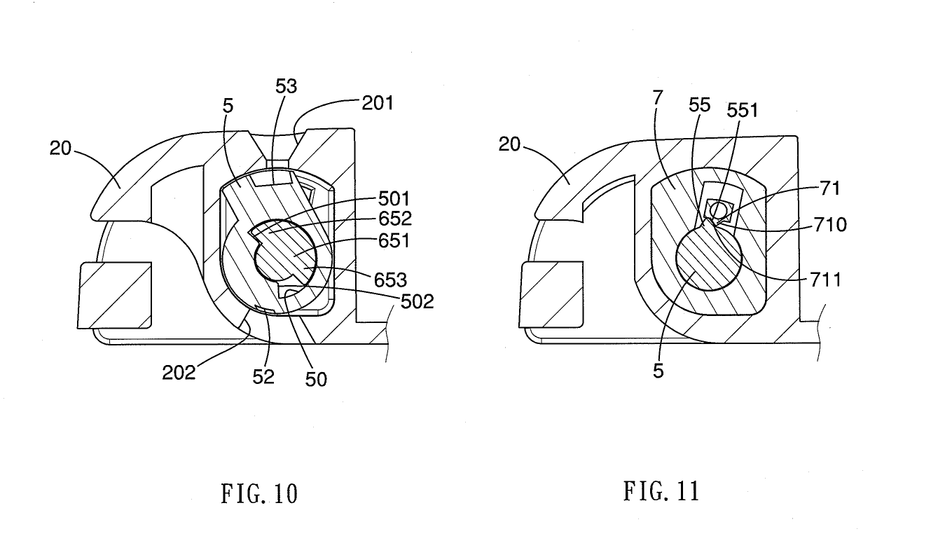

Moreover, referring to FIG. 3, the indicator 5 includes a recess 52 that includes a first wall 521 and a second wall 522. Referring to FIG. 4, the body 20 of the receptacle 2 includes an aperture 202 made in the bottom thereof. The recess 52 is moved toward the second wall 522 from the first wall 521 and aligned with the aperture 202 as shown in FIG. 10 when the indicator 5 is moved into the indicating position from the original position. The recess 52 is not aligned with the aperture 202 as shown in FIG. 6 when the indicator 5 is not in the indicating position.

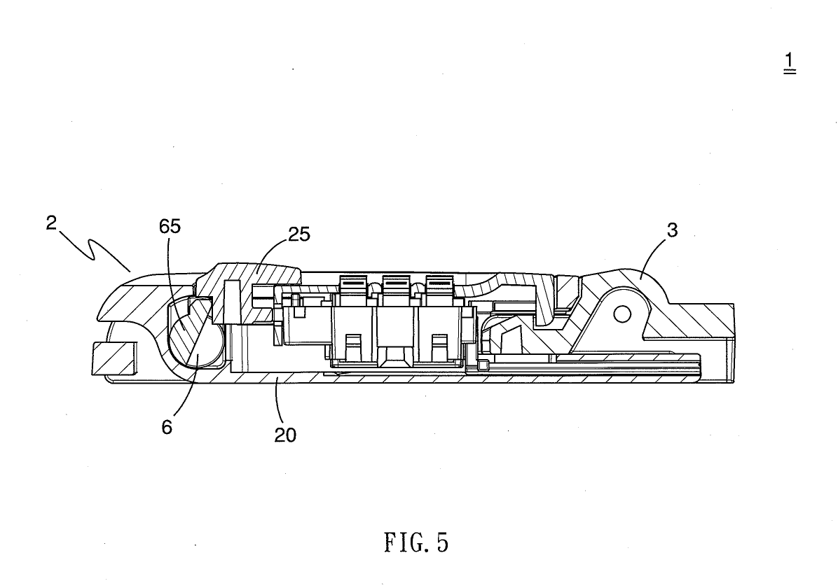

Referring to FIG. 5, the key-operable locking mechanism 6 is in the locking position. Now, the block 65 of the key-operable locking mechanism 6 is engaged with the plate 25 of the receptacle 2 so that the plate 25 cannot be pushed so that the tongue 3 cannot be removed from the receptacle 2. Referring to FIG. 6, the driver of the block 65 is in the middle of the walls 501 and 502 of the bore 50 of the indicator 5. Referring to FIG. 7, the boss 55 of the indicator 5 is placed on a side of the rod 71 of the restraining element 7, and the first contact face 550 of the indicator 5 is in contact with the first slope 710 of the rod 71.

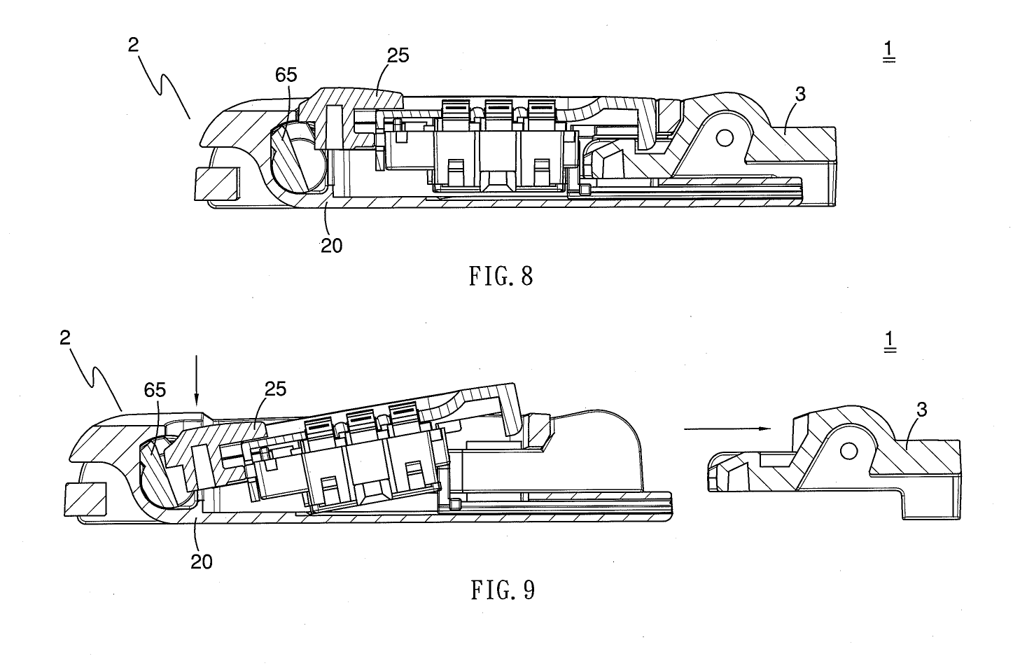

Referring to FIGS. 8 and 9, the core 60 of the key-operable locking mechanism 6 is in the unlocking position, and the core 60 of the key-operable locking mechanism 6 can rotate the block 65 away from the plate 25 of the receptacle 2 so that the plate 25 of the receptacle 2 can be pushed to release the tongue 3 from the receptacle 2.

Referring to FIG. 10, as the block 65 is rotatable by the core 60 of the key-operable locking mechanism 6, the block 65 is rotatable around the axial protrusion 651 of the driver in the bore 50 of the indicator 5, and the upper radial protrusion 652 of the driver can contact the first wall 501 of the bore 50 of the indicator 5 to allow the block 65 to rotate the indicator 5 into the indicating position (FIG. 10) from the original position (FIG. 6). Now, there is a gap between the lower radial protrusion 653 of the driver and the second wall 502 of the bore 50. The indicating area 53 of the indicator 5 is visible in the window 201 of the body 20, and the recess 52 of the indicator 5 is aligned with the aperture 202 of the body 20.

Referring to FIG. 11, as the block 65 is rotatable by the core 60 of the key-operable locking mechanism 6, the boss 55 of the indicator 5 abuts against and slides along the first slope 710 of the rod 71 of the restraining element 7 and then slides onto the second slope 711. In this process, the rod 71, which is a slender element made of plastics, is lifted a little by the boss 55. Then, with inherent elasticity, the rod 71 moves downward back to the original position to stop the boss 55, and the second contact face 551 of the boss 55 abuts against the second slope 711 of the rod 71. Thus, a user can feel a click in the lock 1. The rod 71 is preferably a hollow element to exhibit adequate elasticity.

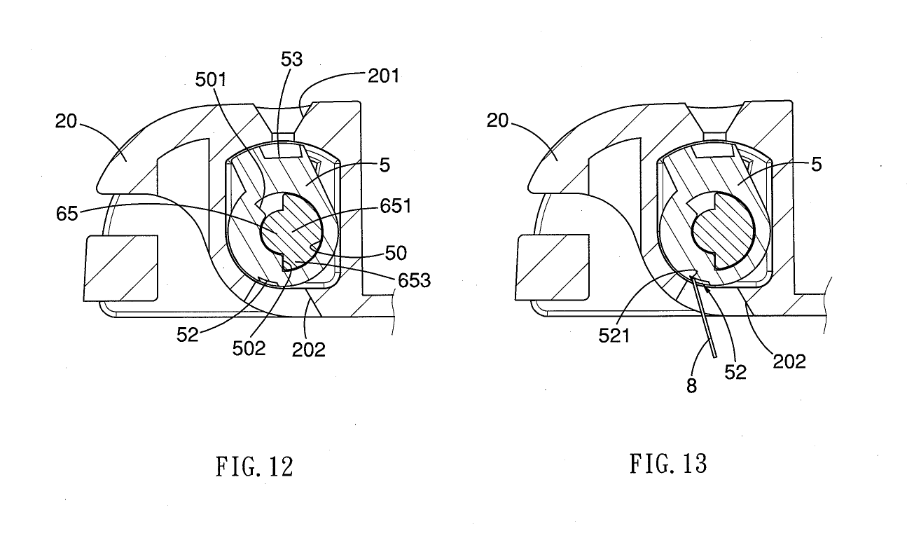

Referring to FIG. 12, as the block 65 is rotated back into the locking position by the core 60 of the key-operable locking mechanism 6, the lower radial protrusion 653 of the driver moves toward and finally contacts the second wall 502 of the bore 50 slightly. It should be noted that the lower radial protrusion 653 of the driver only contacts the second wall 502 slightly without pushing the second wall 502. Hence, as the indicator 5 stays in the indicating position, the lower radial protrusion 653 of the driver of the block 65 cannot rotate the indicator 5 back into the original position. Referring to FIG. 11, the rod 71 of the restraining element 7 is engaged with the boss 55 of the indicator 5 (the second contact face 551 of the boss 55 abuts against the second slope 711 of the rod 71) to prevent the block 65 from returning the indicator 5 into the original position due to friction between the wall of the bore 50 of the indicator 5 and the driver of the block 65. In brief, the rod 71 is useful for temporarily retaining the indicator 5 in the indicating position.

Referring to FIG. 13, the indicator 5 is in the indicating position, and the recess 52 is aligned with the aperture 202 of the body 20. A tool 8 can be inserted in the aperture 202 of the body 20 and abutted against the first wall 521 of the recess 52 of the indicator 5 to rotate the indicator 5 back into the original position.

As discussed above, the lock 1 of the present invention is provided with the rotational indicator 5. The driver of the key-operable locking mechanism 6 is inserted in the recess 52 of the indicator 5. With the design of the driver corresponding to the recess 52, the indicator 5 stays in the indicating position, i.e., the key-operable locking mechanism 6 cannot return the indicator 5 into the original position after the key-operable locking mechanism 6 rotates the indicator 5 into the indicating position. Moreover, with the design of the boss 55 of the indicator 5 corresponding to the rod 71 of the restraining element 7 of the receptacle 2, the indicator 5 can be positioned better. That is, the indicator 5 is temporarily retained in the indicating position and cannot be returned into the original position by the key-operable locking mechanism 6 after the indicator 5 is rotated into the indicating position by the key-operable locking mechanism 6.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A lock including:
a body;
a key-operable locking mechanism placed in the body, wherein the key-operable locking mechanism includes:
a core including a key hole in a front end; and
a block connected to a rear end of the core and formed with an axial protrusion, an upper radial protrusion on an upper face of the axial protrusion, a lower radial protrusion on a lower face of the axial protrusion, wherein the core can rotate the block about the axial protrusion into an unlocking position from a locking position; and
an indicator placed in the body and formed with a recess for receiving the block, wherein the recess includes a first wall for contact with the upper radial protrusion of the block and a second wall for contact with the lower radial protrusion of the block, wherein the indicator is rotatable into an indicating position from an original position;
wherein the upper radial protrusion of the block abuts the first wall of the recess to rotate the indicator into the indicating position from the original position when the core rotates the block into the unlocking position, wherein there is a gap between the lower radial protrusion of the block and the second wall of the recess to allow the lower radial protrusion of the block to move toward the second wall of the recess when the core returns the block into the locking position.

2. The lock according to claim 1, wherein the body includes a recess and a rod formed in the recess and formed with a first slope and a second slope, wherein the indicator includes a boss placed in the recess of the body and formed with a first contact face and a second contact face, wherein the boss is on a side of the rod so that the first contact face of the boss contacts the first slope of the rod when the indicator is in the original position, wherein the boss moves onto another side of the rod so that the second contact face of the boss contacts the first slope of the rod when the indicator is moved into the indicating position.

3. The lock according to claim 2, wherein the rod is a hollow element.

4. The lock according to claim 2, wherein the indicator includes a recess formed with a first wall and a second wall, wherein the body includes an aperture, the recess of the indicator is moved in the direction toward the second wall from the first wall and aligned with the aperture of the body when the indicator is moved to the indicating position from the original position, wherein the indicator can be returned into the original position by a tool abutted against the first wall of the recess of the indicator via the aperture of the body.

5. The lock according to claim 1, wherein the indicator includes a recess formed with a first wall and a second wall, wherein the body includes an aperture, the recess of the indicator is moved in the direction toward the second wall from the first wall and aligned with the aperture of the body when the indicator is moved to the indicating position from the original position, wherein the indicator can be returned into the original position by a tool abutted against the first wall of the recess of the indicator via the aperture of the body.

6. A lock including:
a receptacle;
a tongue detachably engaged with the receptacle;
a strap connected to the receptacle at an end and connected to the tongue at another end;
a key-operable locking mechanism placed in the receptacle, wherein the key-operable locking mechanism includes:
a core including a key hole in a front end; and
a block connected to a rear end of the core and formed with an axial protrusion, an upper radial protrusion on an upper face of the axial protrusion, a lower radial protrusion on a lower face of the axial protrusion, wherein the core can rotate the block about the axial protrusion into an unlocking position from a locking position; and
an indicator placed in the receptacle and formed with a recess for receiving the block, wherein the recess includes a first wall for contact with the upper radial protrusion of the block and a second wall for contact with the lower radial protrusion of the block, wherein the indicator is rotatable into an indicating position from an original position;
wherein the upper radial protrusion of the block abuts the first wall of the recess to rotate the indicator into the indicating position from the original position when the core rotates the block into the unlocking position, wherein there is a gap between the lower radial protrusion of the block and the second wall of the recess to allow the lower radial protrusion of the block to move toward the second wall of the recess when the core returns the block into the locking position.
